(19) United States
(12) Patent Application Publication
(10) Pub. No.: US 2026/0317191 A1
(43) Pub. Date: Oct. 15, 2026

(54) METHOD OF PREPARING CALCIUM HYDROXIDE FROM CALCIUM COMPOUNDS

(71) Applicant: SOGANG UNIVERSITY RESEARCH & BUSINESS DEVELOPMENT FOUNDATION, Seoul (KR)

(72) Inventors: Nam Hwi HUR, Seoul (KR); Hee Sun PARK, Seoul (KR)

(73) Assignee: SOGANG UNIVERSITY RESEARCH & BUSINESS DEVELOPMENT FOUNDATION, Seoul (KR)

(21) Appl. No.: 19/482,036

(22) PCT Filed: Jun. 14, 2024
(86) PCT No.: PCT/KR2024/008175

§ 371 Date: Nov. 6, 2025

(30) Foreign Application Priority Data
Jun. 16, 2023 (KR) 10-2023-0077530

(51) Int. Cl. C01F 11/02; B01J 23/46; B01J 35/70

(52) U.S. Cl. CPC C01F 11/02; B01J 23/462; B01J 35/70; C01P 2002/72; C01P 2006/80

(57) ABSTRACT

The present invention relates to a method for producing calcium hydroxide from a calcium compound such as limestone. The method for producing calcium hydroxide according to embodiments of the present invention is an environmentally friendly process that does not emit carbon dioxide compared to conventional methods. Furthermore, since it does not require a high-temperature heat treatment process to produce calcium oxide (CaO), it can be performed at a lower temperature than conventional calcium hydroxide production methods, resulting in an economical process with lower energy costs.

### CROSS REFERENCE TO RELATED APPLICATION(S)

This application is a national entry of International Application No. PCT/KR2024/008175 filed Jun. 14, 2024, which claims priority to and benefits of Korean Patent Application No. 10-2023-0077530 under 35 U.S.C. § 119(a) and § 365(b), filed on Jun. 16, 2023 in the Korean Intellectual Property Office, the entire contents of which are incorporated herein by reference.

### BACKGROUND

### 1. Technical Field

The present disclosure relates to a method for preparing calcium hydroxide from limestone or calcium compounds.

### 2. Description of the Related Art

Calcium hydroxide (Ca(OH)₂) is a basic material having strong basicity. Because it is environmentally friendly and harmless to the human body, it is utilized in various industries such as construction, steelmaking, water treatment, agriculture, and food. For example, calcium hydroxide is used for safe treatment of industrial waste. Direct landfill of acidic industrial waste can cause fatal environmental pollution of the soil; thus, calcium hydroxide is used as a neutralizer in processes treating large volumes of waste acid water generated in steelmaking and metal smelting processes. Recently, it has been used as a neutralizer for high-concentration acidic wastewater containing phosphoric acid (H₃PO₄) or hydrofluoric acid (HF) from semiconductor processes.

Low-purity calcium hydroxide is used as a neutralizing agent for acidic wastewater, as an inorganic coagulant for water and sewage treatment, and as a purifying agent for improving water quality in lakes and rivers. On the other hand, fine calcium hydroxide powder of purity 90% or higher is used for reduction of air pollution, significantly reducing air pollutants such as sulfur oxides (SOx), nitrogen oxides (NOx), and carbon monoxide. High-grade calcium hydroxide with purity 95% or higher and with good color tone and powder shape is used as a food additive or for refining sugar or raw sugar.

A conventional method of preparing calcium hydroxide involves a relatively simple process of reacting calcium oxide (CaO) with water as shown in Reaction Formula 1 below. However, the raw material calcium oxide is produced by heat-treating limestone (CaCO₃) at high temperature (≥900 °C), resulting in high energy cost. In addition, the conventional method emits a large amount of carbon dioxide according to Reaction Formula 2 below:

CaO+H₂O→Ca(OH)₂. [Reaction Formula 1]

CaCO₃→CaO+CO₂. [Reaction Formula 2]

Since limestone also contains impurities other than calcium carbonate. In the conventional process where crushed limestone is used directly without separation, the resulting calcium oxide has low purity with remaining impurities. Even after hydration during calcium hydroxide formation, these impurities remain, making additional purification steps necessary to obtain high-purity calcium hydroxide.

Therefore, there is a need for development of an economical, eco-friendly low-temperature manufacturing process of high-purity calcium hydroxide that does not require a high-temperature heat treatment.

### PRIOR ART DOCUMENT

(Patent Document 1) Republic of Korea Patent Publication No. 10-2013-7025562

### SUMMARY

The object of the present disclosure is to provide a method for preparing calcium hydroxide from limestone or calcium compounds.

However, the problems to be solved are not limited to those described above, and other problems will be apparent to one of ordinary skill in the art from the following description.

A first aspect of the present disclosure provides a method for preparing calcium hydroxide, the method comprising: performing a catalytic reaction of a calcium compound (such as limestone), nitric acid, and hydrogen to obtain calcium hydroxide and an ammonia compound.

A second aspect of the present disclosure provides a ruthenium oxide catalyst that is represented by Chemical Formula I, wherein the ruthenium oxide catalyst has a monoclinic structure, and is used in the method for preparing calcium hydroxide according to the first aspect:

HₓRuO₂ [Chemical Formula I]

In Chemical Formula I, 0<x≤4

The method of preparing calcium hydroxide according to embodiments of the present disclosure does not require a high-temperature heat treatment process to produce calcium oxide, and therefore can be conducted at lower temperature, reducing energy cost.

The method according to the present disclosure provides an environmentally friendly process that does not release carbon dioxide.

The method enables co-production of valuable ammonia compounds.

The yield of calcium hydroxide obtained may be at least about 60%, 70%, 80%, 85%, 90%, 95%, 96%, or 97%.

The catalyst used does not melt or collapse during reaction and can be easily separated and reused, resulting in long-term reaction applicability and cost-efficiency.

The catalyst has high activity and enables efficient production of calcium hydroxide with high yield.

### BRIEF DESCRIPTION OF THE DRAWINGS

FIG. 1 is a schematic diagram of a reaction for obtaining calcium hydroxide (Ca(OH)₂) and an ammonia compound by catalytically reacting nitric acid and hydrogen including calcium carbonate (CaCO₃), in one embodiment of the present disclosure.

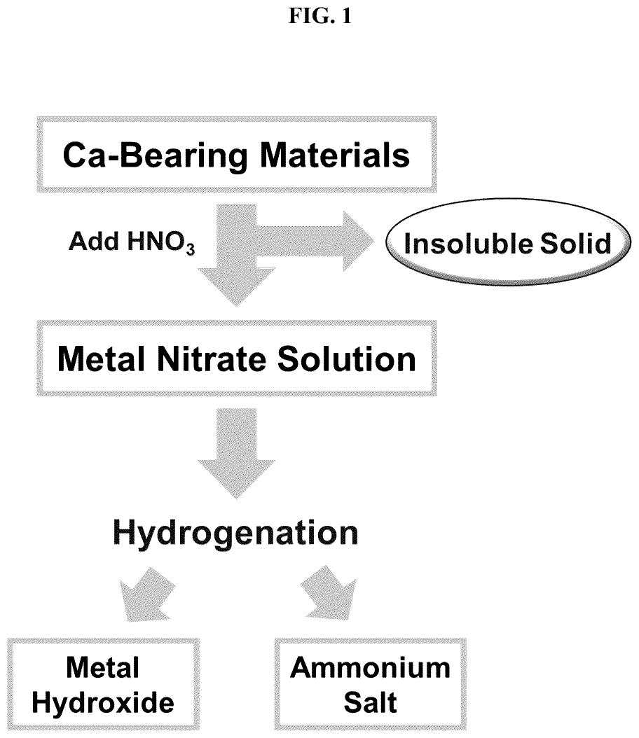

FIG. 2 is a powder X-ray diffraction (PXRD) graph of Ca(OH)₂ prepared according to Example 1 of the present disclosure.

FIG. 3 is a powder X-ray diffraction graph of NH₄NO₃ prepared according to Example 1 of the present disclosure.

FIG. 4 is a powder X-ray diffraction graph of limestone, which is a reactant in Example 5 of the present disclosure.

FIG. 5 is a powder X-ray diffraction graph of Ca(OH)₂ prepared according to Example 5 of the present disclosure.

### DETAILED DESCRIPTION OF THE EMBODIMENTS

Hereinafter, embodiments and examples of the present disclosure will be described in detail with reference to the accompanying drawings so that those of ordinary skill in the technical field to which the invention pertains can easily carry it out. However, the present disclosure may be embodied in many different forms and is not limited to the embodiments and examples described herein. In the drawings, for the sake of clarity, parts that are not related to the explanation have been omitted, and like reference numerals are given to like parts throughout the specification.

Throughout the present specification, when a part is “connected” to another part, this includes both cases of being “directly connected” and cases of being “electrically connected” with another element in between.

Throughout the specification, when a member is described as being “on” another member, this includes both the case of the member being in contact with the other member and the case of another member being interposed therebetween.

Throughout the specification, when it is stated that a part “includes” or “comprises” a certain element, unless specifically described otherwise, it does not exclude other elements but can further include other elements.

The degree terms such as “about,” “substantially,” and the like used throughout the specification are used in a sense close to the numerically stated value when a manufacturing or material tolerance is presented in the stated meaning, and are used to prevent an unscrupulous infringer from improperly exploiting disclosed contents referring to exact or absolute numerical values for misleading advantage.

Throughout the specification, the term “a step of ~” or “the step of ~” does not mean “a step for ~.”

Throughout the specification, the term “the combination(s) thereof” included in a Markush-type expression means one or more mixtures or combinations selected from the group consisting of the elements stated in the expression, and means inclusion of one or more selected from the group consisting of the above elements.

Throughout the specification, “A and/or B” means “A or B, or both A and B.”

Although embodiments of the present disclosure will be described in detail below, it should not be construed as being limited thereto.

A first aspect of the present disclosure provides a method for preparing calcium hydroxide, the method comprising: performing a catalytic reaction of a calcium compound (such as limestone), nitric acid, and hydrogen to obtain calcium hydroxide and an ammonia compound.

In one embodiment, calcium compound may be an ore such as limestone, whose main component is calcium carbonate (CaCO₃), and other components may be included, and it may be extended to ranges where the present invention can be applied. Examples of the calcium compound may include marble, calcite, aragonite, limestone, iceland spar, chalk, travertine, shell, eggshell, and coral, which each contain calcium carbonate.

In one embodiment, the calcium compound may include one or more of a calcium-containing process byproduct or waste, and a calcium salt compound.

In one embodiment, the calcium-containing process byproduct or waste may include one or more of slag and waste concrete.

In one embodiment, within the range where the invention can apply, the calcium salt compound refers to salts containing calcium and is not limited thereto. In one embodiment, the calcium salt compound may include at least one of slag, waste concrete, a calcium-containing chloride, a calcium-containing oxide, a calcium-containing sulfide, a calcium-containing carbonate, a calcium-containing nitrate, a calcium-containing phosphate, a calcium-containing sulfate, a calcium-containing silicate, and a calcium-containing hydrate. Non-limiting examples may include a calcium chloride (e.g., CaCl₂), a calcium nitrate (e.g., Ca(NO₃)₂), a calcium oxide (e.g., CaO), a calcium silicate (e.g., calcium silicate), or a calcium sulfate (CaSO₄).

In one embodiment, a concentration of the nitric acid may be in a range of about 0.1 M to about 16 M but is not limited thereto. In one embodiment of the present invention, the concentration of the nitric acid is in a range of about 0.1 M to about 16 M, about 0.1 M to about 14 M, about 0.1 M to about 12 M, about 0.1 M to about 10 M, about 0.1 M to about 8 M, about 0.1 M to about 6 M, about 0.1 M to about 5 M, about 0.1 M to about 4 M, about 0.1 M to about 3 M, about 0.1 M to about 2 M, about 0.1 M to about 1 M, about 1 M to about 16 M, about 1 M to about 14 M, about 1 M to about 12 M, about 1 M to about 10 M, about 1 M to about 8 M, about 1 M to about 6 M, about 1 M to about 5 M, about 1 M to about 4 M, about 1 M to about 3 M, about 1 M to about 2 M, about 2 M to about 16 M, about 2 M to about 14 M, about 2 M to about 12 M, about 2 M to about 10 M, about 2 M to about 8 M, about 2 M to about 6 M, about 2 M to about 5 M, about 2 M to about 4 M, about 2 M to about 3 M, about 3 M to about 16 M, about 3 M to about 14 M, about 3 M to about 12 M, about 3 M to about 10 M, about 3 M to about 8 M, about 3 M to about 6 M, about 3 M to about 5 M, about 3 M to about 4 M, about 4 M to about 16 M, about 4 M to about 14 M, about 4 M to about 12 M, about 4 M to about 10 M, about 4 M to about 8 M, about 4 M to about 6 M, about 4 M to about 5 M, about 5 M to about 16 M, about 5 M to about 14 M, about 5 M to about 12 M, about 5 M to about 10 M, about 5 M to about 8 M, about 5 M to about 6 M, about 6 M to about 16 M, about 6 M to about 14 M, about 6 M to about 10 M, about 6 M to about 8 M, about 6 M to about 7 M, about 8 M to about 16 M, about 8 M to about 14 M, about 8 M to about 12 M, about 8 M to about 10 M, about 10 M to about 16 M, about 10 M to about 14 M, about 10 M to about 12 M, about 12 M to about 16 M, about 12 M to about 14 M, or about 14 M to about 16 M. In one embodiment, when the concentration of the nitric acid is less than about 0.1 M, the generation rate of calcium hydroxide becomes slow, and when the concentration exceeds about 16 M, the yield of calcium hydroxide may decrease due to the high acidity.

In one embodiment, the catalytic reaction uses a catalyst that may be metals, alloys, or oxides comprising at least one of titanium (Ti), vanadium (V), chromium (Cr), manganese (Mn), iron (Fe), cobalt (Co), nickel (Ni), copper (Cu), zinc (Zn), molybdenum (Mo), indium (In), tin (Sn), phosphorus (P), aluminum (Al), silicon (Si), ruthenium (Ru), rhodium (Rh), palladium (Pd), silver (Ag), tungsten (W), rhenium (Re), osmium (Os), iridium (Ir), platinum (Pt), and gold (Au).

In one embodiment, the catalyst may include a ruthenium oxide represented by Chemical Formula I:

HₓRuO₂ [Chemical Formula I]

In Chemical Formula I, 0<x≤4.

In one embodiment, when the particle diameter of the catalyst is about 10 nm or less, the reaction activity may be enhanced, but it is not limited thereto. In one embodiment, the catalyst may have a particle diameter of about 10 nm or less, about 8 nm or less, about 6 nm or less, or about 4 nm or less.

In one embodiment, the catalyst does not melt or collapse in structure during reaction, allowing reaction for a long time.

In one embodiment, the catalyst may be separated and recovered for reuse after the reaction is complete.

In one embodiment, although the catalytic reaction using ruthenium oxide represented by Chemical Formula I is preferable in terms of activity and/or stability, other metals or metal salts may additionally be used as co-catalysts.

In one embodiment, an amount of the catalyst used in the catalytic reaction may be in a range of about 0.1 parts by weight to about 10 parts by weight, relative to 100 parts by weight of the calcium compound. In one embodiment of the present invention, an amount of the catalyst in a range of about 0.1 parts by weight to about 10 parts by weight, about 0.1 parts by weight to about 9 parts by weight, about 0.1 parts by weight to about 8 parts by weight, about 0.1 parts by weight to about 7 parts by weight, about 0.1 parts by weight to about 6 parts by weight, about 0.1 parts by weight to about 5 parts by weight, about 0.1 parts by weight to about 4 parts by weight, about 0.1 parts by weight to about 3 parts by weight, about 0.1 parts by weight to about 2 parts by weight, about 0.1 parts by weight to about 1 part by weight, about 1 part by weight to about 10 parts by weight, about 1 part by weight to about 9 parts by weight, about 1 part by weight to about 8 parts by weight, about 1 part by weight to about 7 parts by weight, about 1 part by weight to about 6 parts by weight, about 1 part by weight to about 5 parts by weight, about 1 part by weight to about 4 parts by weight, about 1 part by weight to about 3 parts by weight, about 1 part by weight to about 2 parts by weight, about 2 parts by weight to about 10 parts by weight, about 2 parts by weight to about 9 parts by weight, about 2 parts by weight to about 8 parts by weight, about 2 parts by weight to about 7 parts by weight, about 2 parts by weight to about 6 parts by weight, about 2 parts by weight to about 5 parts by weight, about 2 parts by weight to about 4 parts by weight, about 2 parts by weight to about 3 parts by weight, about 3 parts by weight to about 10 parts by weight, about 3 parts by weight to about 9 parts by weight, about 3 parts by weight to about 8 parts by weight, about 3 parts by weight to about 7 parts by weight, about 3 parts by weight to about 6 parts by weight, about 3 parts by weight to about 5 parts by weight, about 3 parts by weight to about 4 parts by weight, about 4 parts by weight to about 10 parts by weight, about 4 parts by weight to about 9 parts by weight, about 4 parts by weight to about 8 parts by weight, about 4 parts by weight to about 7 parts by weight, about 4 parts by weight to about 6 parts by weight, about 4 parts by weight to about 5 parts by weight, about 5 parts by weight to about 10 parts by weight, about 5 parts by weight to about 9 parts by weight, about 5 parts by weight to about 8 parts by weight, about 5 parts by weight to about 7 parts by weight, about 5 parts by weight to about 6 parts by weight, about 6 parts by weight to about 10 parts by weight, about 6 parts by weight to about 9 parts by weight, about 6 parts by weight to about 8 parts by weight, about 6 parts by weight to about 7 parts by weight, about 7 parts by weight to about 10 parts by weight, about 7 parts by weight to about 9 parts by weight, about 7 parts by weight to about 8 parts by weight, about 8 parts by weight to about 10 parts by weight, about 8 parts by weight to about 9 parts by weight, or about 9 parts by weight to about 10 parts by weight. In one embodiment, if the catalyst is used at less than about 0.1 parts by weight relative to 100 parts by weight of the calcium compound, the hydrogenation reaction time may be prolonged and/or the reaction may not be completed. If the catalyst is used at more than about 10 parts by weight, the reaction rate may increase, but the separation efficiency between the products and the catalyst may decrease in the separation process.

In one embodiment, the catalytic reaction may be performed at a temperature in a range of about 20 °C to about 200 °C. In one embodiment of the present invention, the catalytic reaction is performed at a temperature in a range of about 20 °C to about 200 °C, about 20 °C to about 190 °C, about 20 °C to about 180 °C, about 20 °C to about 170 °C, about 20 °C to about 160 °C, about 20 °C to about 150 °C, about 20 °C to about 140 °C, about 20 °C to about 130 °C, about 30 °C to about 200 °C, about 30 °C to about 190 °C, about 30 °C to about 180 °C, about 30 °C to about 170 °C, about 30 °C to about 160 °C, about 30 °C to about 150 °C, about 30 °C to about 140 °C, about 30 °C to about 130 °C, about 40 °C to about 200 °C, about 40 °C to about 190 °C, about 40 °C to about 180 °C, about 40 °C to about 170 °C, about 40 °C to about 160 °C, about 40 °C to about 150 °C, about 40 °C to about 140 °C, about 40 °C to about 130 °C, about 50 °C to about 200 °C, about 50 °C to about 190 °C, about 50 °C to about 180 °C, about 50 °C to about 170 °C, about 50 °C to about 160 °C, about 50 °C to about 150 °C, about 50 °C to about 140 °C, or about 50 °C to about 130 °C. Most preferably, the catalytic reaction may be performed at a temperature in a range of about 60 °C and about 120 °C.

In one embodiment, the catalytic reaction may be performed in a hydrothermal reactor.

In one embodiment, the hydrogen may be at a pressure in a range of about 0.1 MPa to about 10 MPa. In one embodiment of the present invention, the hydrogen is at a pressure in a range of about 0.1 MPa to about 10 MPa, about 0.1 MPa to about 9 MPa, about 0.1 MPa to about 8 MPa, about 0.1 MPa to about 7 MPa, about 0.1 MPa to about 6 MPa, about 0.1 MPa to about 5 MPa, about 0.1 MPa to about 4 MPa, about 0.1 MPa to about 3 MPa, about 1 MPa to about 10 MPa, about 1 MPa to about 9 MPa, about 1 MPa to about 8 MPa, about 1 MPa to about 7 MPa, about 1 MPa to about 6 MPa, about 1 MPa to about 5 MPa, about 1 MPa to about 4 MPa, about 1 MPa to about 3 MPa, about 1.5 MPa to about 10 MPa, about 1.5 to about 9 MPa, about 1.5 MPa to about 8 MPa, about 1.5 MPa to about 7 MPa, about 1.5 MPa to about 6 MPa, about 1.5 MPa to about 5 MPa, about 1.5 MPa to about 4 MPa, or about 1.5 MPa to about 3 MPa. When the hydrogen is at a pressure that is less than about 0.1 MPa, the reaction progress rate may be very slow, and when the hydrogen is at a pressure that is greater than about 10 MPa, the reaction may not proceed smoothly. Preferably, the hydrogen may be at a pressure of about 2 MPa.

In one embodiment, the calcium hydroxide may be obtained as a precipitate of the solution by filtration, but it is not limited thereto. In one embodiment, the ammonia compound may be obtained in the form of ammonia by adding carbon dioxide or an acid to the solution, but it is not limited thereto.

In one embodiment, after the calcium hydroxide preparation reaction, separating the catalyst may additionally be included. In one embodiment, after the hydrogenation reaction, separating a precipitate containing the catalyst and calcium hydroxide may additionally be included.

In one embodiment, adding an inorganic acid to the hydrogenation reaction product to obtain an ammonium salt may additionally be included. In one embodiment, the inorganic acid may be sulfuric acid, nitric acid, hydrochloric acid, or acetic acid but is not limited thereto. In one embodiment, the ammonium salt may be ammonium sulfate ((NH₄)₂SO₄), ammonium bisulfate (NH₄HSO₄), ammonium nitrate (NH₄NO₃), ammonium chloride (NH₄Cl), or ammonium acetate (NH₄CH₃CO₂), and the ammonium salt may vary depending on the type of inorganic acid. Here, the yield of ammonium ions can be calculated through the weight of the obtained ammonium salts; this may be an additional experimentally confirmed figure obtained during the process of separating and collecting actual ammonium salts for use after generating ammonia from nitrate ions.

A second aspect of the present disclosure provides a ruthenium oxide catalyst represented by Chemical Formula I, wherein the ruthenium oxide catalyst has a monoclinic structure, and is used in the method for preparing calcium hydroxide according to the first aspect:

HₓRuO₂ [Chemical Formula I]

In Chemical Formula I, 0<x≤4

Although detailed explanations overlapping with the first aspect are omitted, the descriptions made with respect to the first aspect shall apply equally to the second aspect even when omitted herein.

In one embodiment of the present invention, in Chemical Formula I, x (the atomic ratio of hydrogen) is greater than 0 and less than 4, greater than 0 and about 3.5 or less, greater than 0 and about 3 or less, greater than 0 and about 2.5 or less, greater than 0 and about 2 or less, greater than 0 and about 1.5 or less, greater than 0 and about 1.2 or less, about 0.1 to about 4, about 0.1 to about 3.5, about 0.1 to about 3, about 0.1 to about 2.5, about 0.1 to about 2, about 0.1 to about 1.5, about 0.1 to about 1.2, about 0.2 to about 3.5, about 0.2 to about 3, about 0.2 to about 2.5, about 0.2 to about 2, about 0.2 to about 1.5, about 0.2 to about 1.2, about 0.3 to about 3.5, about 0.3 to about 3, about 0.3 to about 2.5, about 0.3 to about 2, about 0.3 to about 1.5, about 0.3 to about 1.2, about 0.4 to about 3.5, about 0.4 to about 3, about 0.4 to about 2.5, about 0.4 to about 2, about 0.4 to about 1.5, or about 0.4 to about 1.2, but may not be limited thereto. In one embodiment of the present disclosure, in Chemical Formula I, x may be about 0.4 to about 1.2.

In one embodiment of the present invention, in Chemical Formula I, the closer x (the atomic ratio of hydrogen) is to about 1, the easier it is to produce the monoclinic ruthenium oxide. Specifically, in Chemical Formula I, when the atomic ratio of hydrogen is about 0.6 to about 1.4, the monoclinic ruthenium oxide may be easier to produce. When x is 0 in Chemical Formula I, a structural transition to a tetragonal rutile ruthenium oxide may occur, so it is preferable to maintain the hydrogen content.

In one embodiment, the atomic ratio of hydrogen included in Chemical Formula I may be calculated by thermo-gravimetric analysis (TGA). Specifically, in the analysis using TGA, a solid sample is placed in a platinum crucible and its weight change is measured while increasing the temperature. Hydrogen contained in the monoclinic ruthenium oxide (HₓRuO₂) is completely removed and converted into tetragonal ruthenium oxide (RuO₂), and the amount of hydrogen can be quantitatively analyzed from the change in weight with temperature.

In one embodiment of the present invention, the ruthenium oxide catalyst has diffraction peaks that are observed at incident angles (2θ) of 18.38°<2θ<18.42°, 25.45°<2θ<25.51°, 26.26°<2θ<26.32°, 33.45°<2θ<33.51°, 35.28°<2θ<35.34°, 36.24°<2θ<36.30°, 37.32°<2θ<37.38°, 39.55°<2θ<39.61°, 40.61°<2θ<40.67°, 41.46°<2θ<41.52°, 49.17°<2θ<49.23°, 52.31°<2θ<52.37°, 54.03°<2θ<54.09°, 54.70°<2θ<54.76°, 55.95°<2θ<56.01°, 59.97°<2θ<60.03°, 60.40°<2θ<60.46°, 61.92°<2θ<61.98°, 63.94°<2θ<64.00°, 65.79°<2θ<65.85°, and 69.13°<2θ<69.19°. In one embodiment of the present invention, the ruthenium oxide catalyst may have diffraction peaks observed at positions where the incident angles (2θ) determined by X-ray powder diffraction measurement (Cu Kα line) are 18.40°, 25.48°, 26.29°, 33.48°, 35.31°, 36.27°, 37.35°, 39.58°, 40.64°, 41.49°, 49.20°, 52.34°, 54.06°, 54.73°, 55.98°, 58.00°, 60.43°, 61.95°, 63.97°, 65.82°, and 69.16°.

In one embodiment, the ruthenium oxide catalyst may have a monoclinic crystal system structure of space group P2₁/c, C2/m, P2/c, C2/c, P2/m, or P2₁/m, but is not limited thereto.

In one embodiment, the unit cell of the monoclinic crystal structure may be defined by lattice constants a, b, and c, and by the interaxial angle beta (β).

In one embodiment of the present invention, in the monoclinic structure, 5 Å≤a≤6 Å, 5 Å≤b≤6 Å, 5 Å≤c≤6 Å, and the beta (β) angle may be in a range of about 110° to about 120°. For example, a, b, and c are each in a range of about 5 Å to about 6 Å, about 5.1 Å to about 6 Å, about 5.2 Å to about 6 Å, about 5.3 Å to about 6 Å, about 5 Å to about 5.8 Å, about 5.1 Å to about 5.8 Å, about 5.2 Å to about 5.8 Å, about 5.3 to about 5.8 Å, about 5 Å to about 5.6 Å, about 5.1 Å to about 5.6 Å, about 5.2 Å to about 5.6 Å, about 5.3 Å to about 5.6 Å, about 5 Å to about 5.4 Å, about 5.1 Å to about 5.4 Å, about 5.2 Å to about 5.4 Å, about 5.3 Å to about 5.4 Å, or about 5.35 Å to about 5.4 Å, wherein b may be about 5 Å to about 6 Å, about 5 Å to about 5.8 Å, about 5 Å to about 5.6 Å, about 5 Å to about 5.4 Å, about 5 Å to about 5.2 Å, or about 5 Å to about 5.1 Å; and the beta (β) angle is in a range of about 110° to about 120°, about 112° to about 120°, about 114° to about 120°, about 110° to about 118°, about 112° to about 118°, about 114° to about 118°, about 110° to about 116°, about 112° to about 116°, or about 114° to about 116°.

In one embodiment, in the monoclinic structure, a=5.3533 Å, b=5.0770 Å, c=5.3532 Å, and the β angle may be 115.9074°, but is not limited thereto.

Hereinafter, the present invention will be described in more detail using examples. However, the following examples are provided only to help understand the present invention, and the contents of the present invention are not limited to the following examples.

### EXAMPLES

### Example 1

0.2 g of CaCO₃ (2.00 mmol), 20 mg of HₓRuO₂ (0.15 mmol), and 2 mL of 2.0 M HNO₃ were placed in a hydrothermal reactor. The reactor was then filled with hydrogen at a pressure of 2.0 MPa, and the reaction was conducted at 100 °C for 10 hours. After completion of the reaction, the hydrothermal reactor was cooled to room temperature, and the resulting precipitate and residual solution were separated.

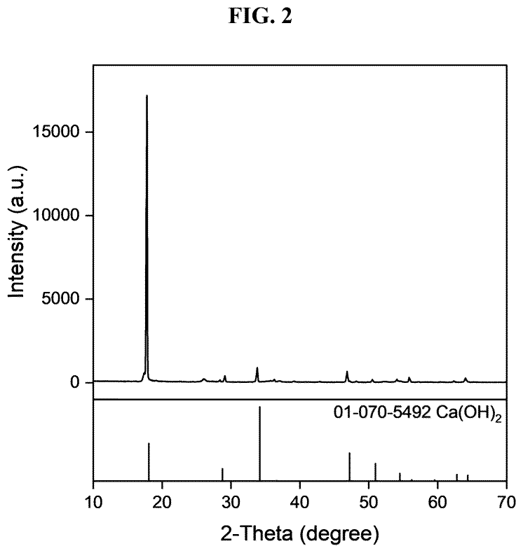

The precipitate was dried and identified as calcium hydroxide (Ca(OH)₂) by X-ray powder diffraction analysis (see FIG. 2). The mass of the obtained Ca(OH)₂ was 0.145 g (1.96 mmol), and the yield of Ca(OH)₂ calculated based on CaCO₃ was 97.9%.

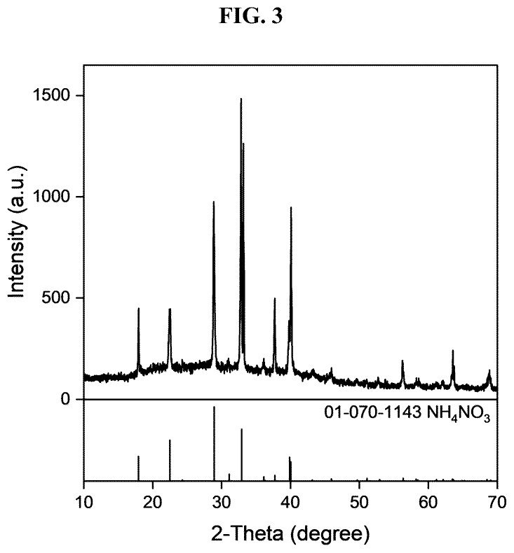

After the reaction, the residual solution was analyzed by ultraviolet-visible spectroscopy, and nitrogen oxide ions (NO₃⁻ and NO₂⁻) were not detected, confirming that all nitrate ions were reduced to ammonia or nitrogen. Nitric acid was added to the residual solution and evaporated to obtain crystals, which were confirmed to be ammonium nitrate (NH₄NO₃) by X-ray powder diffraction (see FIG. 3). The mass of the obtained NH₄NO₃ was 0.301 g (3.76 mmol), and the yield calculated based on HNO₃ was 94.1%.

### Example 2

A hydrogenation reaction was performed in the same manner as in Example 1, except that the reaction was performed under a hydrogen pressure of 5.0 MPa. The precipitate formed after the reaction was dried and confirmed to be Ca(OH)₂ by X-ray powder diffraction analysis. The mass of the obtained Ca(OH)₂ was 0.139 g (1.88 mmol), and the yield of Ca(OH)₂ calculated based on CaCO₃ was 93.8%.

After the reaction, nitric acid was added to the residual solution and evaporated to obtain crystals, which were confirmed to be ammonium nitrate (NH₄NO₃) by X-ray powder diffraction analysis. The mass of the obtained NH₄NO₃ was 0.313 g (3.91 mmol), and the yield calculated based on HNO₃ was 97.8%.

### Example 3

A hydrogenation reaction was performed using the same method as Example 1, except that an additional 2 mL of distilled water was added. The precipitate formed after the reaction was dried and identified as Ca(OH)₂ by X-ray powder diffraction analysis. The mass of the obtained Ca(OH)₂ was 0.125 g (1.69 mmol), and the yield of Ca(OH)₂ calculated based on CaCO₃ was 84.3%.

After the reaction, nitric acid was added to the remaining solution and evaporated to obtain crystals. These crystals were identified as ammonium nitrate (NH₄NO₃) by X-ray powder diffraction analysis. The mass of the obtained NH₄NO₃ was 0.294 g (3.67 mmol), and the yield calculated based on HNO₃ was 91.9%.

### Example 4

A hydrogenation reaction was performed using the same method as Example 1, except that the reaction was performed at 60 °C. The precipitate formed after the reaction was dried and identified as Ca(OH)₂ by X-ray powder diffraction analysis. The mass of the resulting Ca(OH)₂ was 0.087 g (1.17 mmol), and the yield of Ca(OH)₂ calculated based on CaCO₃ was 58.7%.

After the reaction, nitric acid was added to the remaining solution and evaporated to obtain crystals. These crystals were identified as ammonium nitrate (NH₄NO₃) by X-ray powder diffraction analysis. The mass of the resulting NH₄NO₃ was 0.183 g (2.29 mmol), and the yield calculated based on HNO₃ was 57.2%.

### Example 5

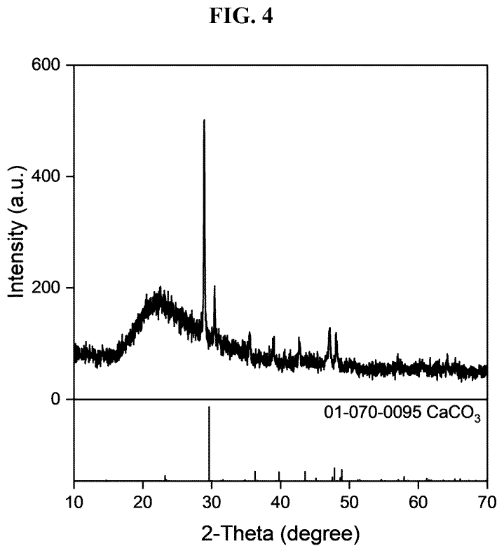

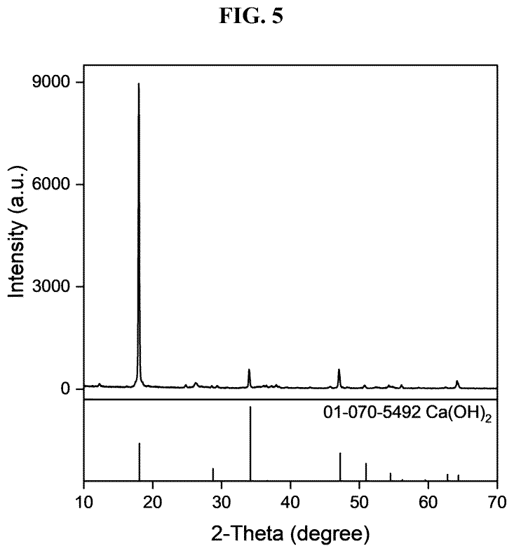

The hydrogenation reaction was performed using the same method as in Example 1, except that 0.2 g of commercial limestone (see FIG. 4) was dissolved in nitric acid instead of calcium carbonate as the reactant, and the undissolved solid was separated and used for the reaction. The precipitate formed after the reaction was dried and identified as Ca(OH)₂ by X-ray powder diffraction analysis (see FIG. 5). The mass of the obtained Ca(OH)₂ was 0.107 g (1.44 mmol).

### Example 6

The reaction was performed in the same manner as Example 1, except that ruthenium powder (7.6 mg, 0.075 mmol) was used as the catalyst. After completion of the reaction, the yield of Ca(OH)₂ was very small, less than 5%.

### Example 7

The reaction was performed in the same manner as Example 1, except that platinum powder (14.6 mg, 0.075 mmol) was used as the catalyst. After completion of the reaction, the mass of the obtained Ca(OH)₂ was 0.115 g (1.55 mmol), and the yield of Ca(OH)₂ calculated based on CaCO₃ was 77.6%. The mass of the obtained NH₄NO₃ was 0.232 g (2.88 mmol), and the yield calculated based on HNO₃ was 72.5%.

### Example 8

The reaction was performed in the same manner as Example 1, except that palladium powder (8.0 mg, 0.075 mmol) was used as the catalyst. After the reaction was completed, the mass of the obtained Ca(OH)₂ was 0.120 g (1.62 mmol), and the yield calculated based on CaCO₃ was 81.0%. The mass of the obtained NH₄NO₃ was 0.256 g (3.20 mmol), and the yield calculated based on HNO₃ was 80.0%.

### Example 9

The reaction was performed in the same manner as Example 1, except that nickel powder (7.1 mg, 0.075 mmol) was used as the catalyst. After the reaction was completed, the yield ratio of the obtained Ca(OH)₂ was less than 5%, so a very small amount was obtained.

The above description of the present invention is for illustrative purposes only, and those skilled in the art will readily appreciate that the present invention can be readily modified into other specific forms without altering the technical spirit or essential characteristics of the present invention. Therefore, the embodiments described above should be understood as illustrative in all respects and not restrictive. For example, each component described as a single entity may be implemented in a distributed manner, and similarly, components described as distributed may be implemented in a combined manner.

What is claimed is:

1. A method for producing calcium hydroxide, the method comprising:
performing a catalytic reaction of a calcium compound, nitric acid, and hydrogen to produce calcium hydroxide and an ammonia compound.

2. The method of claim 1, wherein the calcium compound is marble, calcite, aragonite, limestone, iceland spar, chalk, travertine, shells, eggshells, or coral.

3. The method of claim 1, wherein the calcium compound is limestone.

4. The method of claim 1, wherein the calcium compound is calcium carbonate.

5. The method of claim 1, wherein the calcium compound comprises:
at least one of a calcium-containing process byproduct or waste, and a calcium salt compound.

6. The method of claim 5, wherein
the calcium-containing process byproduct or waste comprises at least one of slag and waste concrete, and
the calcium salt compound comprises at least one of a calcium-containing chloride, a calcium-containing oxide, a calcium-containing sulfide, a calcium-containing carbonate, a calcium-containing nitrate, a calcium-containing phosphate, a calcium-containing sulfate, a calcium-containing silicate, and a calcium-containing hydrate.

7. The method of claim 1, wherein the catalytic reaction uses a catalyst that is a metal, an alloy, or an oxide of at least one of titanium (Ti), vanadium (V), chromium (Cr), manganese (Mn), iron (Fe), cobalt (Co), nickel (Ni), copper (Cu), zinc (Zn), molybdenum (Mo), indium (In), tin (Sn), phosphorus (P), aluminum (Al), silicon (Si), ruthenium (Ru), rhodium (Rh), palladium (Pd), silver (Ag), tungsten (W), rhenium (Re), osmium (Os), iridium (Ir), platinum (Pt), and gold (Au).

8. The method of claim 7, wherein the catalyst comprises a ruthenium oxide represented by Chemical Formula I:
HₓRuO₂ [Chemical Formula I]
wherein in Chemical Formula I,
0<x≤4.

9. The method of claim 1, wherein the catalytic reaction uses a catalyst at an amount in a range of about 0.1 parts by weight to about 10 parts by weight, relative to 100 parts by weight of the calcium compound.

10. The method of claim 1, wherein the catalytic reaction is performed at a temperature in a range of about 20 °C to about 200 °C.

11. The of claim 1, wherein the catalytic reaction is performed in a hydrothermal reactor.

12. The method of claim 1, wherein the hydrogen is at a pressure in a range of about 0.1 MPa to about 10 MPa.

13. The method of claim 1, wherein a concentration of the nitric acid in a range of about 0.1 M to about 16 M.

14. The method of claim 1, wherein the catalytic reaction is performed in a solution containing a solvent.

15. The method of claim 14, wherein the solvent is distilled water, methanol, or ethanol.

16. A ruthenium oxide catalyst represented by Chemical Formula I, wherein
the ruthenium oxide catalyst a monoclinic structure, and is used in the method of claim 1:
HₓRuO₂ [Chemical Formula I]
wherein in Chemical Formula I,
0<x≤4.

17. The ruthenium oxide catalyst of claim 16, wherein
the ruthenium oxide catalyst has diffraction peaks that are observed at incident angles (2θ) of 18.38°<2θ<18.42°, 25.45°<2θ<25.51°, 26.26°<2θ<26.32°, 33.45°<2θ<33.51°, 35.28°<2θ<35.34°, 36.24°<2θ<36.30°, 37.32°<2θ<37.38°, 39.55°<2θ<39.61°, 40.61°<2θ<40.67°, 41.46°<2θ<41.52°, 49.17°<2θ<49.23°, 52.31°<2θ<52.37°, 54.03°<2θ<54.09°, 54.70°<2θ<54.76°, 55.95°<2θ<56.01°, 59.97°<2θ<60.03°, 60.40°<2θ<60.46°, 61.92°<2θ<61.98°, 63.94°<2θ<64.00°, 65.79°<2θ<65.85°, and 69.13°<2θ<69.19°.

18. The ruthenium oxide catalyst of claim 16, wherein the ruthenium oxide catalyst has a monoclinic crystal system structure of space group P2₁/c, C2/m, P2/c, C2/c, P2/m, or P2₁/m.

19. The ruthenium oxide catalyst of claim 16, wherein, in the monoclinic structure,
5 Å≤a≤6 Å,
5 Å≤b≤6 Å,
5 Å≤c≤6 Å, and
the beta (β) angle is in a range of about 110° to about 120°.

20. The ruthenium oxide catalyst according to claim 16, wherein, in the monoclinic structure,
a=5.3533 Å,
b=5.0770 Å,
c=5.3532 Å, and
the beta (β) angle is 115.9074°.
